(19) United States
(12) Patent Application Publication
(10) Pub. No.: US 2008/0019473 A1
(43) Pub. Date: Jan. 24, 2008

(54) Computer Tomography Method and Computer Tomograph

(75) Inventor: Thomas Koehler, Norderstedt (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 11/720,107

(22) PCT Filed: Nov. 17, 2005
(86) PCT No.: PCT/IB05/53796

§ 371 Date: May 24, 2007

(30) Foreign Application Priority Data
Nov. 24, 2004 (EP) 04106040.1

(51) Int. Cl. G01N 23/00

(52) U.S. Cl. 378/4

(57) ABSTRACT

The invention describes a computer tomography method, in which a provided marker is reconstructed in order to determine the image resolution during the image reconstruction. The invention furthermore discloses a computer tomograph comprising a patient table for supporting a patient in order to expose said patient to X-ray radiation, wherein at least one marker for determining the image resolution during the image reconstruction is arranged on the patient table.

The invention relates to a computer tomography method as claimed in the preamble of claim 1 and to a computer tomograph as claimed in the preamble of claim 7.

In the field of computer tomography, extensive data records of the examination object are produced which, in the course of data processing by means of image reconstruction, are converted into images on the output device of the computer tomograph. For image reconstruction, use is made inter alia of iterative mathematical methods in which the image is generated in successive mathematical approximation steps. Iterative image reconstruction comprises, alternately, projection steps and back-projection steps which involve a high degree of computing power, wherein the iterative reconstruction method slowly converges, in particular in dependence on the examination object. The number of mathematical approximation steps required for a sufficient image result is typically between three and ten. It is not possible to predict how many approximation steps will be required in the iterative reconstruction method before an image result having a desired image resolution is achieved.

It is an object of the invention to determine the image resolution during a reconstruction method, with low complexity.

According to the invention, this object is achieved by the features of claims 1 and 7.

The invention provides a computer tomography method, in which a provided marker is reconstructed in order to determine the image resolution during the image reconstruction. The invention furthermore provides a computer tomograph comprising a patient table for supporting a patient in order to expose said patient to X-ray radiation, wherein markers for determining the image resolution during the image reconstruction are arranged on the patient table. The invention makes it possible, with little calculation complexity and during the computer tomography recording, to determine the image resolution of the object to be examined on the basis of the image resolution of the marker, which can be determined easily.

Embodiments of the invention are described in the dependent claims.

The marker may furthermore be arranged on the patient table. The marker then follows the same advance movement as the object or the patient, and is continuously present in the recorded image.

In one embodiment, a maximum likelihood method is used as the image reconstruction method. This image reconstruction method has proven advantageous for use in connection with the invention.

Furthermore, the image resolution determined by means of the marker may serve to stop the image reconstruction method. The reconstruction of the image during the computer tomography recording is performed only until a certain image resolution is achieved, said image resolution being sufficient for the subsequent assessment of the computer tomography images by the user. The computing time for the reconstruction can usually be shortened as a result. A saving is made in terms of expensive treatment times, the throughput of patients on the computer tomography device is increased, since rapid results are obtained and the user can assess after a short time whether or not further X-ray imaging is necessary in order to increase the image resolution, and the computer tomography recording can be ended when there is a sufficient image resolution without waiting on the lengthy reconstruction of the patient images.

In one embodiment, the image resolution of the marker is determined by means of a frequency analysis of the reconstructed measured data of the marker. For this purpose, a frequency analyzer is provided in the reconstruction unit, which frequency analyzer deduces the image resolution of the markers on the basis of the frequencies of the recorded image data.

Moreover, the marker may be fitted in the patient table. Said marker is then permanently integrated and can no longer slip on the patient table or be lost.

In one particular embodiment, the marker comprises Plexiglas. This is a common, inexpensive and robust material which is easy to form into a marker. There is preferably a high contrast between the Plexiglas and the surroundings of the marker.

In a further embodiment, the marker comprises plastic. This is a common, inexpensive and robust material which is easy to form into a marker. There is preferably a high contrast between the plastic and the surroundings of the marker.

In order to carry out the method according to the invention, at least two markers may be oriented parallel to the patient table and at least two other markers may be oriented perpendicular to the patient table. The markers are then arranged on the patient table at right angles to one another. It has furthermore proven advantageous if the markers have a diameter of 1 cm and a thickness of 0.4 mm.

The invention will be further described with reference to examples of embodiments shown in the drawings to which, however, the invention is not restricted.

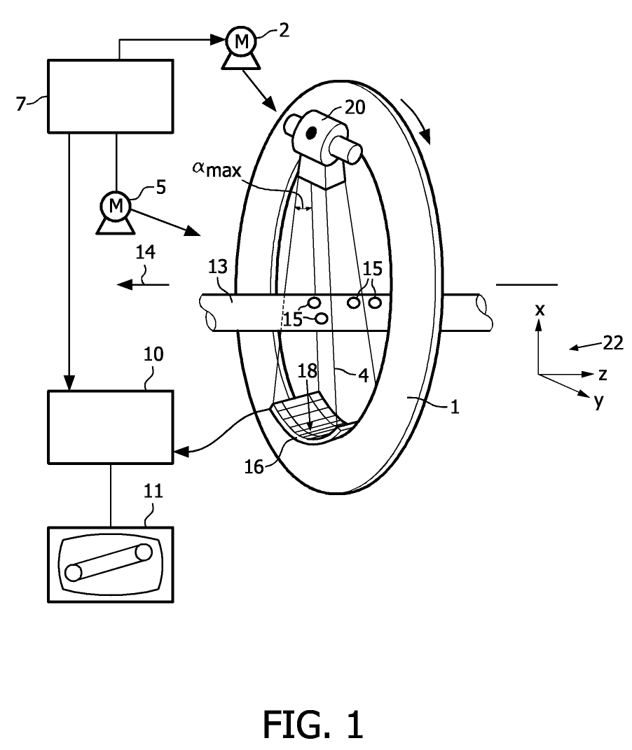

FIG. 1 shows a schematic diagram of part of a computer tomograph for recording images of an examination object, comprising a patient table with applied markers.

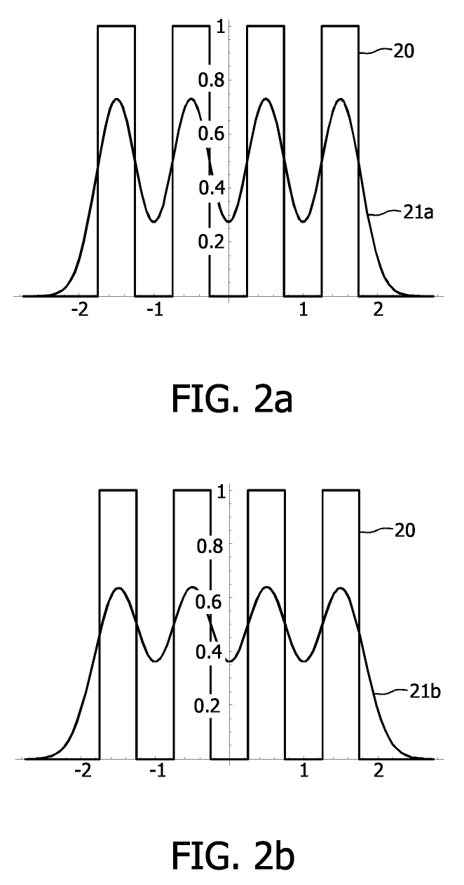

FIG. 2a shows by way of example a density profile of measured values with a square-wave curve and also the corresponding reconstructed density profile with a sinusoidal curve.

FIG. 2b shows a diagram as shown in FIG. 2a, with a lower image resolution.

The schematic diagram of part of a computer tomograph which is shown in FIG. 1 comprises a gantry 1, which carries a radiation source 20 and a detector unit 16 and can rotate about an axis of rotation 14 that runs parallel to the z-axis. To this end, the gantry 1 is driven by a motor 2 at a preferably constant but controllable angular speed. The radiation source 20, for example an X-ray tube, is fixed to the gantry 1. Said radiation source is provided with a collimator arrangement 3 which forms a cone-shaped beam bundle 4 from the radiation produced by the radiation source 20. The beam bundle 4 passes through a patient table 13 which is shown schematically, said patient table usually being occupied by a patient. Once it has passed through the patient table 13, the beam bundle 4 strikes a two-dimensional detector unit 16 which is fixed to the gantry 1. The opening angle β of the beam bundle 4 (the opening angle is the angle enclosed by the rays of the beam bundle 4 which lie at the edge in the xy plane) defines the width of the patient table 13 within which the object to be examined (the patient) must be located during the acquisition of the measured values. The patient table 13 with the patient can be displaced parallel to the direction of the axis of rotation 14 or z-axis by means of a further motor 5.

The opening angle α of the beam bundle 4 is the angle enclosed by rays at the edge of the beam bundle 4 which lie in the plane defined by the axis of rotation 14 and the radiation source 20. The opening angle α defines the segment of the examination area which is passed through by rays during a rotation about the axis of rotation 14.

The measured data acquired by the detector unit 16 are passed to a reconstruction unit 10 which reconstructs therefrom the absorption distribution in the part of the patient table 13 covered by the beam cone 4 and displays it for example on a monitor 11. The two motors 2 and 5, the reconstruction unit 10, the radiation source 20 and the transfer of the measured data from the detector unit 16 to the reconstruction unit 10 are controlled by a suitable control unit 7.

The motors 2 and 5 are controlled in such a way that the ratio of the advance speed of the examination area 13 to the angular speed of the gantry 1 are in a constant ratio, so that radiation source 20 and patient table 13 move relative to one another on a helical path or detector path, the so-called trajectory. It does not matter here whether it is the scanning unit consisting of radiation source 20 and detector 16 or the patient table 13 which carries out the rotary and advance movements; only the relative movement is important.

In the recording described here by way of example with a helical or circular path of the radiation source 20 about the patient table 13, recorded data are generated which are reconstructed in a subsequent image reconstruction method in the reconstruction unit 10 to form an image of the patient.

Applied to the patient table 13 are markers 15 which are shown schematically as ovals or circles and are disk-shaped or spherical. The markers 15 may be arranged on the patient table 13 or be inserted in the latter, and are located at defined points on the patient table 13. At least two markers 15 are arranged parallel to the longitudinal axis of the patient table 13 and at least two other markers 15 are arranged perpendicular to the longitudinal axis of the patient table 13. In this way, the image resolution in the corresponding directions is detected. Preferably, the markers 15 have a diameter of approximately 1 cm and a thickness of approximately 0.4 mm. The distance between the markers 15 is for example 0.4 mm. In FIG. 1, in each case two markers 15 are arranged parallel to and perpendicular to the longitudinal axis of the patient table 13. Other markers may be used; preferably in each case another two markers 15 at a distance of 5 cm from one another. The markers 15 consist of a material which is highly suitable for detection by means of X-ray radiation. In particular, the markers 15 have a high contrast with respect to their surroundings, so that a clearly detectable edge forms in the X-ray image at the edge between the markers 15 and their surroundings. The markers 15 consist for example of a plastic which is not very transparent to X-ray radiation. Little radiation is then detected behind the markers 15 when seen in the direction of the detector unit 16, whereas a high amount of X-ray radiation is detected by the detector unit 16 in the surroundings of the markers 15 behind the latter. In this respect, reference should also be made to the description relating to FIG. 2a and FIG. 2b. The markers 15 are passed through by the beam bundle 4 and are recorded by the detector unit 16 along with the recorded data of the patient. In the reconstruction unit 10, the iterative reconstruction method for obtaining an image of the patient on the one hand and of the markers 15 on the other hand is implemented. Finally, based on the achieved image resolution of the markers 15, a decision is made as to when the image reconstruction method is terminated.

One example of an iterative reconstruction method is an algebraic reconstruction technique (ART) which is described for example in R. Gordon et al., “Algebraic reconstruction techniques (ART) for three-dimensional electron microscopy and x-ray photography”, J. Theor Biol. Vol. 29, pages 471 to 481, 1970, and this is incorporated in the present description. SART is described for example in R. H. Andersen et al., “Simultaneous algebraic reconstruction technique (SART)”, Ultrasonic imaging, Vol. 6, pages 81 to 94, 1994, and this is incorporated in the present description.

The basic idea of ART is based on a discrete notation I of a continuous object function and on calculating projection data therefrom. The discrete notation I is changed when there is a difference between calculated and measured projection data of the computer tomograph.

Let the measured projection data p consist of a number of X views p1 . . . pX, wherein one individual view is recorded from a given point along the helical path of the radiation source 20 and detector unit 16.

An iteration step k [symbol] k+1 consists of two operations:

1. For a given view n(k), projection data p′ are calculated from an estimated image Iₖ and compared with the measured data pₙ(k). (Projection)
p′=Pₙ₍ₖ₎Iₖ (1)
Pₙ₍ₖ₎ is the projection operator for the view n(k).
2. The estimated image is updated as a function of the observed difference between the measured and calculated projections, and this leads to a new estimate Iₖ₊₁. (Back-projection)
Iₖ₊₁=Iₖ+λₙ₍ₖ₎×Bₙ₍ₖ₎(pₙ₍ₖ₎−p′) (2)
Bₙ₍ₖ₎ is the back-projection operator for the view n(k).

The variable n denotes the order in which the projection data are calculated from various views, written as the formula n:N [symbol] {1, . . . , X}. λ is a significance factor which controls which portion of the observed difference is back-projected in order to obtain the up-to-date image.

Since an iteration step in ART consists of a pair consisting of projection and back-projection, the algebraic reconstruction technique (ART) is altered in order to use different projections at the same time. This leads to a simultaneous algebraic reconstruction technique (SART) which can be used here.

In SART, in each iteration step, written as a formula k [symbol] k+M, M projections/back-projections are calculated simultaneously.

1. Projection data p′ⱼ are calculated from an estimated image Iₖ and compared with the measured data pₙ₍ₖ₊ⱼ₎ for all jε[0, . . . , M−1]. (Projection)
p′ⱼ=Pₙ₍ₖ₊ⱼ₎Iₖ ∀ⱼε[0, . . . , M−1]. (3)
Let
Δⱼ=λₙ₍ₖ₊ⱼ₎(pₙ₍ₖ₊ⱼ₎−p′ⱼ) (4)
2. The estimated image is calculated as a function of the observed difference between the measured and calculated projections, and this leads to a new estimate I_{k+M}. (Back-projection)

$${I}_{k + M} = {I}_{k} + \frac{1}{M} \cdot {\sum }_{j = 0}^{M - 1} {B}_{n ( k + j )} {Δ}_{j} \qquad ( 5 )$$

The factor 1/M in the back-projection step results from the fact that different views, which are recorded from different angles along the detector path, sometimes comprise the same information regarding the object 13. Other iterative reconstruction methods can be carried out, in particular a maximum likelihood method.

Data relating to the patient and relating to the markers 15 are recorded by the detector unit 16 and further processed in the reconstruction unit 10 in the described manner. With regard to the markers 15, it is determined in the reconstruction unit 10 after how many iteration steps k the reconstructed image of the markers 15 has a suitable image resolution. The number of reconstruction steps k is usually in the range from three to ten. Since a high calculation complexity is required for each reconstruction step k, a small number of reconstruction steps k is of particular interest. However, in the prior art, there is no solution for determining the appropriate number of reconstruction step k; the speed at which the algorithm used converges toward a value is unknown. Use is therefore made of the markers 15, wherein the image resolution achieved in the reconstruction after each iteration step k can be determined in a simple manner. In one example, the image resolution is determined by means of a frequency analysis of the image data of the reconstructed image of the markers 15. To this end, a frequency analyzer is provided in the reconstruction unit 10, which frequency analyzer deduces the image resolution of the markers 15 on the basis of the frequencies of the recorded image data. Once a desired high image resolution is achieved, the reconstruction method of the computer tomograph for producing an image of the patient is terminated. In this case, a desirable result is achieved both in terms of the image resolution of the markers 15 and in terms of the image resolution of the image of the patient on the patient table 13. The reconstruction method of the computer tomograph is then terminated, so that it is ascertained, without determining the image resolution of the image of the patient on the basis of the markers 15, at which point in time and after which iteration step k in the reconstruction unit 10 the iterative reconstruction method can be terminated.

FIGS. 2a and 2b show, by way of example, density profiles of measured values of the markers 15 recorded on the detector unit 16, wherein the markers 15 lead to a uniform square-wave curve 20, by virtue of which the markers 15 can be clearly seen. The scale goes up to the number one, wherein the greatest detection of X-ray radiation is at one and the lowest detection of X-ray radiation is at zero. At zero, no X-ray radiation is detected since at these points the markers 15 block the X-ray radiation in the direction of the detector unit 16. In this example, therefore, markers 15 are selected which have a very low transparency to X-ray radiation, the contrast between the regions of the markers 15 and the surroundings is highly pronounced, and easily detectable edges are formed at the jumps of the curve between the values of zero and one. Here, the density profiles of five markers 15 are shown, with accordingly five minima of the detection values, denoted by the numbers (−2, −1, 0, 1, 2). The curve 21a superposed on the square-wave curve 20 represents the square-wave curve 20 of the detection values of the detection unit 16 which has been subjected to a reconstruction method. The course of the curve 21a is similar to the course of the curve 20. The minima and maxima occur at more or less the same points but are much less pronounced; in FIG. 2a, these are approximately at 0.3 and at 0.7. The modulation depth, defined by the difference between the reconstructed maximum of the curve 21a and the reconstructed minimum of the curve 21a divided by a desired value of this difference, is used as a criterion for the image resolution.

It can be seen that, once the reconstruction method has been carried out (shown by the curves 21a, 21b) in order to obtain the image of the markers 15, it is more difficult to distinguish between the maxima and the minima of the detection values and the image resolution is poorer. In FIG. 2b, the minima of the curve 21b are at approximately 0.4 and the maxima are at approximately 0.6; in this reconstructed image of the markers 15 the image resolution is reduced compared to the diagram in FIG. 2a. Based on the curves 21a, 21b, the image resolution of the markers 15 can be determined in the reconstruction unit 10 on the basis of the courses of said curves. For example, in the case of FIG. 2a, the image resolution may be sufficient after a given number of iterative reconstruction steps, whereas in FIG. 2b the image resolution is not sufficient and at least one further iterative reconstruction step is carried out in order to obtain a desired image resolution of the reconstructed image. The further iterative reconstruction step leads to a higher image resolution which is accordingly measured and evaluated in order to ascertain whether the image resolution is sufficient after the further iterative reconstruction step; if not, at least one further iterative reconstruction step is calculated. Once the desired image resolution is achieved, and a given threshold value between the maxima and minima of the curves 21a, 21b is exceeded, the reconstruction of the image of the markers 15 and of the object or patient is terminated and no further iterative reconstruction step is calculated.

The positions of the recorded data of the markers 15 in the recorded data of the computer tomograph are not always known and are therefore sought in the reconstructed recorded data. One possibility for determining the curves 21a, 21b which represent the reconstructed recorded data of the markers 15 is to produce a pattern of a curve course which is similar to the curves 21a, 21b of the reconstructed recorded data of the markers 15, and to seek the pattern in the reconstructed recorded data. By comparing the pattern in a step-wise manner with various points of the reconstructed recorded data, given a high degree of similarity between the pattern and the reconstructed recorded data the position of the curves 21a, 21b of the markers 15 is determined. The similarity between the pattern and the curves 21a, 21b of the reconstructed recorded data of the markers 15 can be determined by means of a cross-correlation method. Once the curves 21a, 21b have been found in this way, the image resolution of the reconstructed image is measured in the manner described above.

1. A computer tomography method, in which a provided marker is reconstructed in order to determine the image resolution during the image reconstruction.

2. A computer tomography method as claimed in claim 1, in which the marker is arranged on the patient table.

3. A computer tomography method as claimed in claim 1, in which an iterative method is used as the image reconstruction method.

4. A computer tomography method as claimed in claim 3, in which a maximum likelihood method is used as the image reconstruction method.

5. A computer tomography method as claimed in claim 1, in which the image resolution determined by means of the marker serves to stop the image reconstruction method.

6. A computer tomography method as claimed in claim 1, in which the image resolution of the marker is determined by means of a frequency analysis of the reconstructed measured data of the marker.

7. A computer tomograph comprising a patient table for supporting a patient in order to expose said patient to X-ray radiation, wherein at least one marker for determining the image resolution during the image reconstruction is arranged on the patient table.

8. A computer tomograph as claimed in claim 7, wherein the marker consists of at least one sphere.

9. A computer tomograph as claimed in claim 7, wherein the marker consists of at least one disk.

10. A computer tomograph as claimed in any of claim 7, wherein the marker is fitted in the patient table.

11. A computer tomograph as claimed in claim 7, wherein the marker comprises Plexiglas.

12. A computer tomograph as claimed in claim 7, wherein the marker comprises plastic.

13. A computer tomograph as claimed in claim 7, wherein at least two markers are oriented parallel to the patient table and at least two other markers are oriented perpendicular to the patient table.

14. A computer tomograph as claimed in claim 7, wherein the marker has a diameter of 1 cm and a thickness of 0.4 mm.
